(19) United States
(12) Patent Application Publication
(10) Pub. No.: US 2020/0148174 A1
(43) Pub. Date: May 14, 2020

(54) MOUNTING PLATE FOR IN-VEHICLE VACUUM CLEANER ASSEMBLY

(71) Applicant: SHOP VAC CORPORATION, Williamsport, PA (US)

(72) Inventor: Jason Gottschall, South Williamsport, PA (US)

(21) Appl. No.: 16/678,048

(22) Filed: Nov. 8, 2019

Related U.S. Application Data
(60) Provisional application No. 62/758,273, filed on Nov. 9, 2018.

(51) Int. Cl. B60S 1/64; A47L 7/00; F16M 13/02

(52) U.S. Cl. CPC B60S 1/64; F16M 13/02; A47L 7/0076

(57) ABSTRACT

A vacuum cleaner assembly configured to be mounted in a vehicle. The vacuum cleaner assembly includes a mounting plate having a vacuum cleaner area, one or more of the tool storage area or a hose storage area, and an accessory storage area. The vacuum cleaner area has an open-ended compartment and a pair of walls disposed adjacent to the open-ended compartment. A vacuum cleaner is disposed in the vacuum cleaner area and includes a collector module and a vacuum module coupled to the collector module. The vacuum module is secured to the vacuum storage area by one or more of the open-ended compartment and the pair of walls disposed adjacent to the open-ended compartment. So constructed, the mounting plate is configured to provide a single piece mounting body for the vacuum cleaner, one or more of the hose and a vacuum cleaner tool, and an accessory package.

### CROSS-REFERENCE TO RELATED APPLICATIONS

This application claims the benefit of U.S. Provisional Application No. 62/758,273 filed Nov. 9, 2018. The entire contents of this application are incorporated herein by reference in their entirety.

### FIELD OF THE INVENTION

The present invention relates generally to a vacuum cleaner configured to be mounted to a vehicle and, more particularly, to a mounting plate for an in-vehicle vacuum cleaner assembly.

### BACKGROUND

In order to clean a vehicle, such as a car or truck, a vacuum cleaner is often used to vacuum out dirt and debris. However, it can be awkward and/or inconvenient to use a typical in-home vacuum cleaner to clean out the interior of a vehicle. To address this inconvenience, attempts have been made to permanently install on-board vehicle vacuum cleaners inside the vehicle. However, the known on-board vehicle vacuum cleaners typically have a complex and dedicated installation arrangement, which limits the usage across different vehicles and/or in different arrangements within a vehicle.

In addition, removal of the vacuum cleaner assembly in a dedicated installation arrangement within the vehicle may be time consuming and difficult. For example, it is often difficult for users to access one or more devices or parts used to help remove the vacuum cleaner assembly from a desired location, such as to remove debris collected in the vacuum cleaner assembly, particularly without spilling the debris. In addition, while some parts may be relatively accessible, they can be heavy or cumbersome to handle, further adding to the difficulties in removing such vacuum cleaner assemblies from various positions within a vehicle.

Further, in many conventional vacuum cleaner assemblies, separate mounting brackets and corresponding fasteners are needed for each of the vacuum cleaner and a hose storage compartment coupled to the vacuum cleaner, for example. In addition, separate compartments are often required and used for various vacuum cleaner tools and accessories, adding to the complexity of installation, use, and storage of all parts of the conventional in-vehicle vacuum cleaner assemblies. As a result, mounting and/or removal of such conventional vacuum cleaner assemblies is typically complex and time consuming and limited in mounting arrangements due to the restrictions in mounting materials and the adaptability and/or flexibility of the same.

### SUMMARY OF THE DISCLOSURE

In accordance with a first exemplary aspect of the present disclosure, a vacuum cleaner assembly configured to be mounted in a vehicle is disclosed. The vacuum cleaner assembly comprises a mounting plate configured to be mounted to a vehicle, and the mounting plate has a vacuum cleaner area, a hose storage area, a tool storage area adapted to receive a tool, and an accessory storage area adapted to receive an accessory package. The vacuum cleaner area has an open-ended compartment and a pair of walls disposed adjacent to the open-ended compartment. In addition, a vacuum cleaner is disposed in the vacuum cleaner area of the mounting plate, and the vacuum cleaner includes a collector module configured to collect debris and having a liner mounted to the vacuum cleaner area and a vacuum module. The vacuum module is configured to draw a vacuum and operatively coupled to the collector. In addition, the vacuum module is secured to the vacuum cleaner area by one or more of the open-ended compartment and the pair of walls disposed adjacent to the open-ended compartment. So constructed, the mounting plate provides a single piece mounting body for the vacuum cleaner and one or more of the tool and the accessory package, allowing ease of installation and removal of the vacuum cleaner assembly.

In accordance with another aspect of the present disclosure, a vacuum cleaner assembly configured to be mounted in a vehicle is disclosed. The vacuum cleaner assembly comprises a mounting plate having a vacuum cleaner area, a hose storage area, and an accessory storage area adapted to store an accessory package. In addition, the vacuum cleaner area has an open-ended compartment and a pair of walls disposed adjacent to the open-ended compartment. A vacuum cleaner is disposed in the vacuum cleaner area of the mounting plate and includes a collector configured to collect debris and having a liner mounted to the vacuum cleaner area, a canister assembly disposed within the liner and a hose extending from the collector into the hose storage area of the mounting plate. A vacuum unit configured to draw a vacuum is operatively coupled to the collector and secured to the vacuum cleaner area by one or more of the open-ended compartment and the pair of walls. So constructed, the mounting plate is configured to provide a single piece mounting body for the vacuum cleaner and one or more of the hose and the accessory package, allowing ease of installation and removal of the vacuum cleaner assembly.

In accordance with yet another aspect of the present disclosure, a mounting plate for a vacuum cleaner assembly configured to be mounted in a vehicle is disclosed. The mounting plate comprises a vacuum cleaner area having an open-ended compartment, a pair of walls, a first side, and a second side. The vacuum cleaner area is adapted to receive a vacuum cleaner having a collector module and a vacuum module operatively coupled to the collector module, where one or more of the open-ended compartment and the pair of walls to secure the vacuum module to the vacuum cleaner area. In addition, the mounting plate comprises one of a hose storage area or a tool storage area disposed adjacent to the first side of the vacuum cleaner area, and an accessory area disposed adjacent to the second side of the vacuum cleaner area, the accessory area adapted to receive an accessory package. So configured, the mounting plate provides a single piece mounting body for the vacuum cleaner assembly.

In further accordance with any one or more of the exemplary aspects, a vacuum cleaner assembly may optionally include any one or more of the following preferred forms.

In some forms, the mounting plate may further include a latch disposed in the vacuum cleaner area, and the vacuum module may be further secured to the vacuum cleaner area by the latch.

In other forms, the tool storage area may be disposed adjacent to the collector module, and the hose storage area may be disposed adjacent to the tool storage area. In addition, the accessory storage area may be disposed adjacent to the open-ended compartment of the vacuum cleaner area.

In still other forms, the mounting plate may further include an exhaust port disposed in one wall of the pair of walls disposed adjacent to the open-ended compartment. One wall of the pair walls may be an outer wall of the pair of walls, enabling exhaust air from the vacuum module to be emitted out of the mounting plate during operation of the vacuum cleaner.

In other aspects, the pair of walls may include an outer wall, and the mounting plate may further include a rear wall, a first exhaust port disposed in the outer wall of the pair of walls of the vacuum storage area, and a second exhaust port disposed in the rear wall of the mounting plate.

In some preferred forms, the collector module may be disposed immediately adjacent to the vacuum module in the vacuum cleaner area of the mounting plate, and the vacuum module may include a motor/impeller unit disposed within a motor housing.

In other preferred forms, the tool storage area of the mounting plate may further include at least one mounting hole for receiving a securing member adapted to secure the mounting plate to the vehicle. In addition, the hose storage area may include a plurality of mounting holes, each mounting hole adapted to receive a securing member adapted to secure the mounting plate to the vehicle.

In still other forms, the tool storage area may include a locking assembly for removably locking a tool in the tool storage area. The locking assembly may include a pair of walls, and each wall of the pair of walls may have an inwardly extending tab. The tabs may contact the tool upon insertion of the tools between the walls to snap the tool into the locking assembly.

In some other preferred forms, the hose storage area of the mounting plate may further include a depth enabling the hose to be disposed in one or more of a serpentine arrangement and multiple layers. In addition, the hose may have an end disposed in the hose storage area.

In still other forms, the open-ended compartment may comprise a C-shaped wall. In addition, the vacuum storage area may include a latch, and the latch may further secure the vacuum module to the vacuum cleaner area.

Additional optional aspects, arrangements, forms, and/or advantages of the vacuum cleaners disclosed herein will be apparent upon consideration of the following detailed description and the appended drawings, each different functionally operable and technically effective combination of which is expressly included as a part of the present disclosure.

### BRIEF DESCRIPTION OF THE DRAWINGS

The Figures described below depict various aspects of the system and methods disclosed therein. It should be understood that each figure depicts an example of a particular aspect of the disclosed system and methods, and that each of the figures is intended to accord with a possible example thereof. Further, wherever possible, the following description refers to the reference numerals included in the following figures, in which features depicted in multiple figures are designated with consistent reference numerals.

There are shown in the drawings arrangements which are presently discussed, it being understood, however, that the present examples are not limited to the precise arrangements and instrumentalities shown, wherein:

FIG. 1 is an isometric view of a vacuum cleaner assembly to be mounted in a vehicle having a mounting plate according to an aspect of the present disclosure;

FIG. 2 is a front view of the vacuum cleaner assembly of FIG. 1;

FIG. 3 is a side view of the vacuum cleaner assembly of FIG. 1;

FIG. 4A is a rear view of the vacuum cleaner assembly of FIG. 1;

FIG. 4B is a bottom view of the vacuum cleaner assembly of FIG. 1;

FIG. 5 is a top view of the vacuum cleaner assembly of FIG. 1;

FIG. 6 is a top sectional view of a vacuum cleaner of the vacuum cleaner assembly of FIG. 5 taken along lines A-A of FIG. 5;

FIG. 7 is a bottom view of the vacuum cleaner assembly of FIG. 1;

FIG. 8 is an isometric view of a mounting plate of the vacuum cleaner assembly of FIG. 1;

FIG. 9 is a top view of the mounting plate of FIG. 8;

FIG. 10 is an isometric view of a vacuum cleaner assembly to be mounted in a vehicle having a mounting plate according to another aspect of the present disclosure;

FIG. 11 is a top view of the vacuum cleaner assembly of FIG. 10;

FIG. 12 is a front sectional view of the vacuum cleaner assembly of FIG. 11 taken along the line B-B of FIG. 11; and

FIG. 13 is an isometric view of the vacuum cleaner assembly of FIG. 10 having a canister assembly of a collector module of the vacuum cleaner assembly removed.

### DETAILED DESCRIPTION

A vacuum cleaner assembly configured to be mounted to a vehicle is disclosed. The vacuum cleaner assembly includes a mounting plate having a vacuum cleaner area, one or more of a hose storage area and a tool storage area, and an accessory storage area. The vacuum cleaner area of the mounting plate includes an open-ended compartment and a pair of walls disposed adjacent to the open-ended compartment. A vacuum cleaner is disposed in the vacuum cleaner area of the mounting plate. The vacuum cleaner includes a collector module configured to collect debris and having a liner mounted to the vacuum cleaner area and a vacuum module operatively coupled to the collector module. The vacuum module is disposed in the open-ended compartment and between the pair of walls of the vacuum cleaner area to secure the vacuum module to the vacuum cleaner area. So configured, the mounting plate provides a single piece mounting body and housing for the vacuum cleaner, a vacuum cleaner tool, a hose of the vacuum cleaner, and an accessory package, allowing easy installation and removal of the vacuum cleaner assembly.

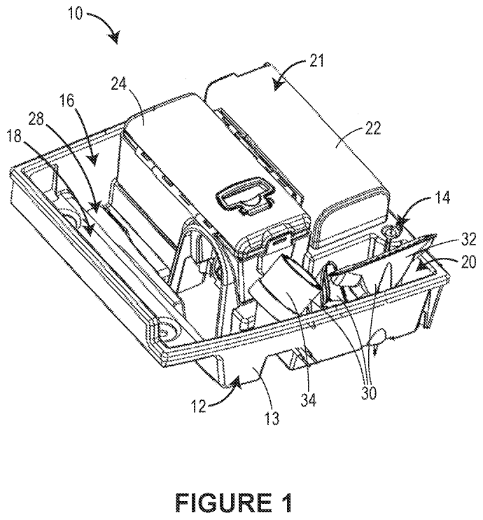

Referring now to FIGS. 1-7, a vacuum cleaner assembly 10 having a mounting plate 12 according the present disclosure is depicted. The vacuum cleaner assembly 10 is configured to be installed and operated within a vehicle, such as a sports utility vehicle or other type of vehicle. In one example, the vacuum cleaner assembly 10 is configured to be installed underneath a rear cargo area floor of the sports utility vehicle to provide easy access for cleaning the interior of the vehicle. In another example, the vacuum cleaner assembly 10 is configured to be installed within a passenger compartment of the vehicle to provide easy access and use of the vacuum cleaner assembly 10 for cleaning the interior of the passenger compartment, for example.

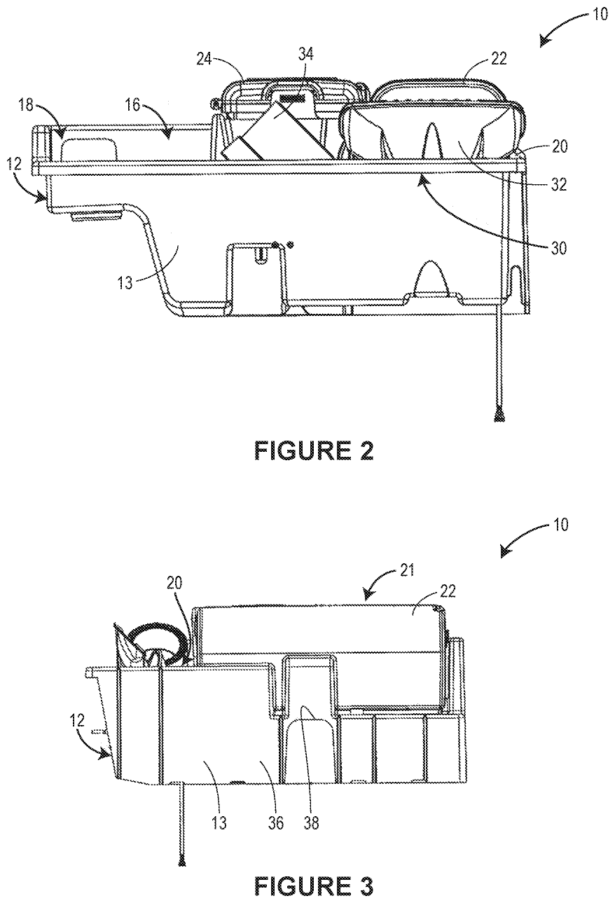

As depicted in FIGS. 1 and 2, the mounting plate 12 includes a body 13 having a vacuum cleaner area 14, a tool storage area 16, a hose storage area 18, and an accessory storage area 20. In some examples, the mounting plate 12 may include the vacuum cleaner area 14 and one or more of the tool storage area 16, the hose storage area 18, and the accessory storage area 20.

A vacuum cleaner 21 is disposed in the vacuum cleaner area 14, as depicted in FIGS. 1-4. In this example, the vacuum cleaner 21 has a modular configuration, as disclosed in the following patents or patent applications, which are each herein incorporated by reference in its entirety: PCT Publication Nos. WO 2018/017568, WO 2018/017579, and WO 2018/017572. For example, the vacuum cleaner 21 includes a vacuum module 22 and a collector module 24 that can be connected to each other as an integrated unit in a plurality of different pre-defined assembly arrangements with an interconnecting duct 26 (FIG. 6). The interconnecting duct 26 may not be flexible, but rather can have a fixed pre-defined shape that allows the collector module 14 to be operatively connected to the vacuum module 12 in only a limited number of predefined assembly arrangements. For example, FIGS. 1-5 depict the vacuum cleaner 21 with the collector module 24 operatively connected to the vacuum module 22 in a side-by-side configuration and an upright installation orientation. Because of its modular configuration, the vacuum cleaner 21 can be easily assembled and/or oriented in many different shapes and orientations.

Alternatively, the vacuum cleaner assembly 10 may be configured and oriented to fit on the side or underneath a seat, in a space along the side wall of a cargo bay or passenger compartment of a sport utility vehicle (SUV) or in the trunk. However, because the interconnecting duct 26 can have a substantially rigid shape and couples the collector module 24 to the vacuum module 22 in pre-defined orientations as an integral unit, the vacuum cleaner 21 can be easily installed and/or removed and/or otherwise moved around as a single unit, which may provide easier handling of the vacuum cleaner 21 as compared to a vacuum cleaner that is not connected together as an integrated unit.

As another alternative, the vacuum cleaner 21 may be of a non-modular configuration and still fall within the scope of the present disclosure. For example, a vacuum cleaner having a tank and a conventional motor may be disposed within the vacuum storage area 14 of the mounting plate 12.

As further depicted in FIG. 1, the tool storage area 16 is disposed adjacent to the vacuum cleaner area 14. The accessory storage area 20 is also disposed adjacent to the vacuum cleaner area 14 of the mounting plate 12, but on another side of the vacuum storage area 14, as explained more below. In addition, the hose storage area is disposed adjacent to the tool storage area 16. Thus, the mounting plate 12, which is adapted to be secured to a vehicle, may include several areas enabling the mounting plate 12 to be single mounting member and a housing for all parts of the vacuum cleaner assembly 10, for example.

In addition, and in this example, a vacuum cleaner tool 28, such as a crevice tool, is disposed in the tool storage area 16 of the mounting plate 12. Also, an accessory package 30 is disposed in the accessory storage area 20 of the mounting plate 12. The accessory package 30 may include various vacuum cleaner accessories, such as one or more of a gulper nozzle 32 and a vacuum brush 34. So constructed, the mounting plate 12 is configured to provide a single piece mounting body and housing for the vacuum cleaner assembly 10, including the vacuum cleaner 21 and the accessory package 30, allowing easy installation and removal of the vacuum cleaner assembly 10 from a vehicle, as explained more below.

Referring now to FIG. 3, the body 13 of the mounting plate 12 further includes an outer wall 36 disposed adjacent to the vacuum module 22 of the vacuum cleaner 21 and an exhaust port 38 disposed in the outer wall 36 near an approximate center area of the vacuum module 22. The exhaust port 38 enables exhaust air from the vacuum module 22, for example, to be emitted out of the mounting plate 12 during operation of the vacuum cleaner 21.

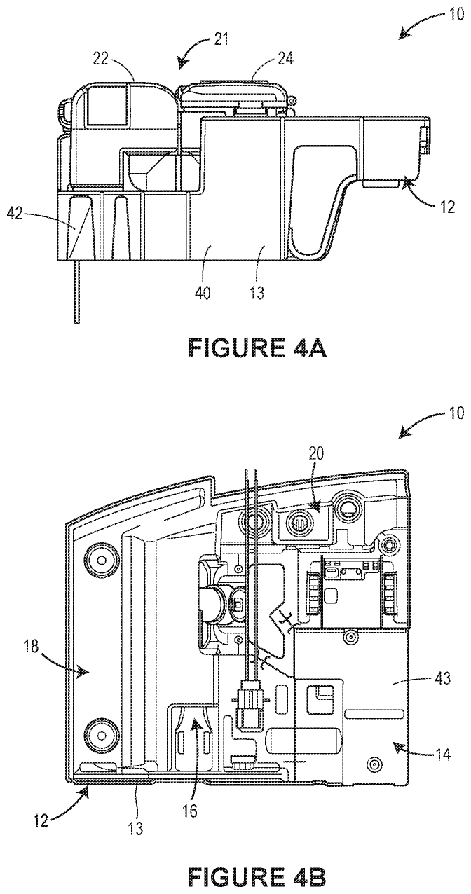

In addition, and as depicted in FIG. 4A, the body 13 of the mounting plate 12 further includes a rear wall 40 having another exhaust port 42. In one example, the exhaust port 38 disposed in the outer wall 36 of the mounting plate 12 near an approximate center area of the vacuum module 22 is a first exhaust port 38, and the exhaust port 42 disposed in the rear wall 40 of the mounting plate 12 is a second exhaust port 42. Like the first exhaust port 38, the exhaust port 42 disposed in the rear wall 40, e.g., the second exhaust port 42, enables exhaust air from the vacuum module 22 of the vacuum cleaner 21 to be emitted out of the mounting plate 12 during operation of the vacuum cleaner 21. In another example, an exhaust port may include an exhaust cover 43 to form a bottom of an exhaust chamber, for example, and as depicted in FIG. 4B.

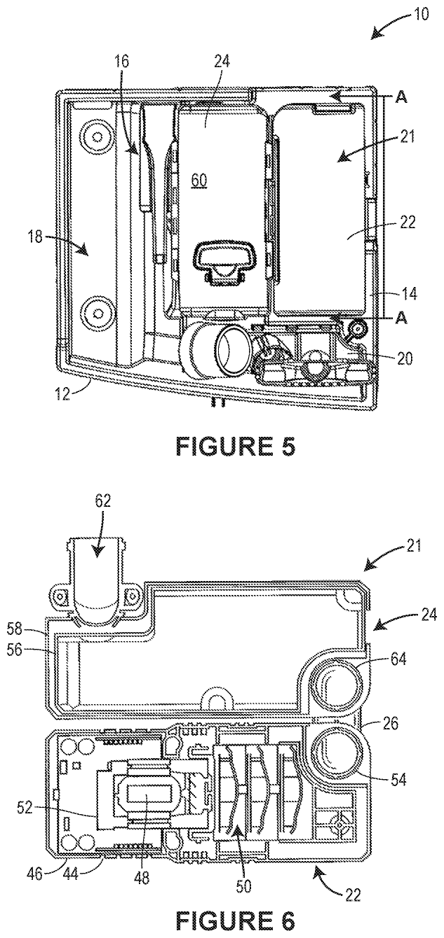

Referring now to FIGS. 5 and 6, the collector module 24 of the vacuum cleaner 21 is disposed immediately adjacent to the vacuum module 22. In addition, the vacuum module 22 includes a motor/impeller unit 44 within a motor housing 46. The motor housing 46 has an outer shell with a generally elongate rectangular form. The motor housing 46 may take many different forms and shapes and sizes depending upon the particular space needs and/or arrangements desired for installation in a particular vehicle and still fall within the scope of the present disclosure. The motor/impeller unit 44 includes a motor 48 that drives an impeller assembly 50, and a controller 52 that controls the motor 48. The motor 48 can be of any design suitable for vacuum cleaners, including standard motors with brushes or brushless motors, and switched reluctance motors. The impeller assembly 50 may take any form suitable for moving air in a manner that will create a vacuum. In this arrangement, the impeller assembly 50 includes three in-line impellers. However, other forms of the impeller assembly 50 may also be used. The motor 48 is operatively coupled to the impeller assembly 50 to drive the impellers to create a vacuum. The controller 52 includes suitable electronics, such as a PCB board and/or other appropriate electronic control circuits configured to control the motor 48. The motor housing 46 includes an intake opening 54 that forms a duct receiver and an air inlet for air that is drawn into the impeller assembly 50.

Still referring to FIGS. 5 and 6, the collector module 24 includes a debris canister assembly 56 disposed within a collector housing 58, e.g., liner. The collector module 24 includes a lid 60 that can be selectively opened to provide access to the debris canister assembly 56. The debris canister assembly 56 is removably received within the collector housing 58 or liner, such that the debris canister assembly 56 can be slidably removed from and returned into the liner 58. The liner 58 may also include an air inlet 62 at one end of the liner 58 and an air exhaust opening 64 at the opposite end of the liner 58. A hose connector 66 extends outwardly from the air inlet 62 for coupling with a vacuum hose. The air exhaust opening 64 also includes a duct receiver and an air outlet.

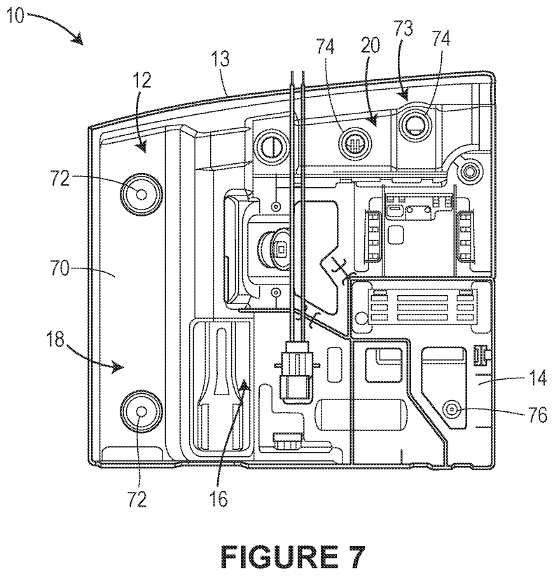

Referring now to FIG. 7, the body 13 of the mounting plate 12 further includes a bottom surface 70. In addition, the hose storage area 18 of the mounting plate 12 further includes at least one mounting hole 72 for receiving a securing member (not shown) to secure the mounting plate 12 and, thus, the vacuum cleaner assembly 10 to a vehicle surface (not depicted). The securing member may be a securing member capable of securing the mounting plate 12 to any portion of a vehicle referred to in this disclosure. In one example, and as depicted n FIG. 7, the hose storage area 18 of the mounting plate 12 includes a pair of mounting holes 72. Further, the accessory storage area 20 may also include one or more mounting holes (not depicted) to further secure the mounting plate to a vehicle surface and undersides of posts 73, 74 that may hold accessories in the accessory storage area 20. In this example, the mounting holes are disposed in essentially the same location as the undersides of the posts 73, 74.

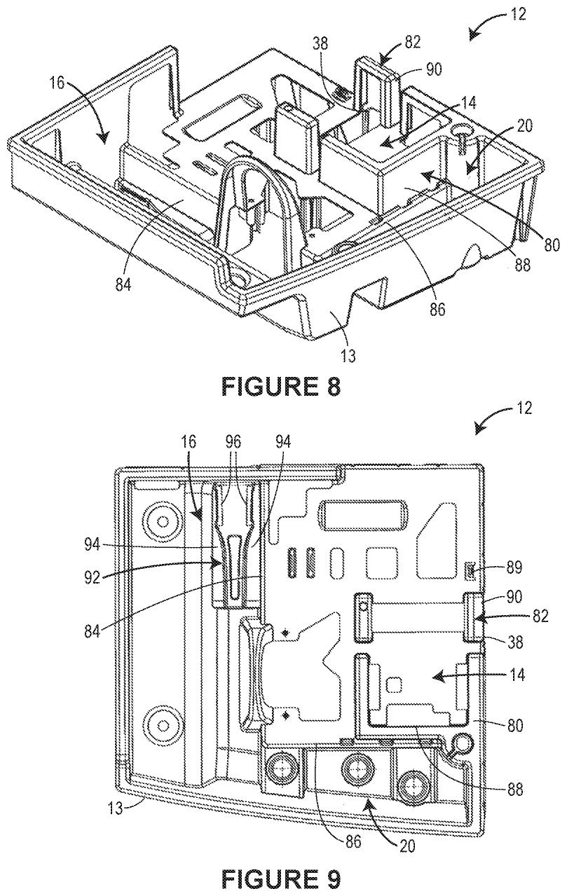

Referring now to FIGS. 8-9, the mounting plate 12 of the vacuum cleaner assembly 10 of FIGS. 1-7 is depicted without the vacuum cleaner 21, the vacuum cleaner tool 28, and the accessory package 30. The vacuum cleaner area 14 of the mounting plate 12 includes an open-ended compartment 80, a pair of walls 82, a first side 84, and a second side 86. One or more of the open-ended compartment 80 and the pair of walls 82 helps secure the vacuum module 22 to the vacuum cleaner area 14 of the mounting plate 12. Said another way, the vacuum module 22 is disposed in the open-ended compartment 80 and between the pair of walls 82 to help secure the vacuum module 22 of the vacuum cleaner 21 to the mounting plate 12. In addition, and as further depicted, the tool storage area 16 is disposed adjacent to the first side 84 of the vacuum storage area 14, and the accessory storage area 20 is disposed adjacent to the second side 86 of the vacuum storage area 14. In other words, the tool storage area 16 is disposed adjacent to the vacuum cleaner area 14, and the accessory storage area 20 is disposed adjacent to the open-ended compartment 80 of the vacuum cleaner area 14. So configured, the mounting plate 12 is configured to provide a single piece mounting body for the vacuum cleaner 21, the tool 28, a hose of the vacuum cleaner 21, and the accessory package 30.

As further depicted, the open-ended compartment 80 may comprise a C-shaped wall 88 and a latch 89 may also be disposed on the vacuum cleaner area 14. The latch 89 is adapted to further secure the vacuum module 21 to the vacuum cleaner area 14 of the mounting plate 12. Further, the exhaust port 38 may be disposed in one wall of the pair of walls 82, the one wall of the pair of walls 82 being an outer wall 90. So constructed, exhaust air from the vacuum module 22 is able to be emitted out of the exhaust port 38 during operation of the vacuum cleaner 21 when disposed on the mounting plate 12.

Still further, and as depicted in FIG. 9, the tool storage area 16 may further include a locking assembly 92 for removably locking a tool, such as the crevice tool 28 (FIG. 1) in the tool storage area 16 of the mounting plate 12. The locking assembly 92 includes a pair of walls 94. At least one wall, and in some cases each wall, of the pair of walls 94 includes an inwardly extending tab 96. The tabs 96 contact the tool, such as the crevice tool 28, upon insertion of the tool between the walls 94 to snap the tool into the locking assembly 92.

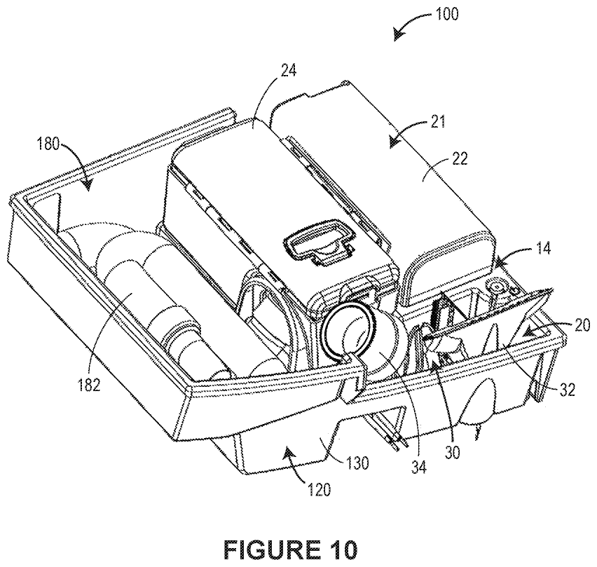

Referring now to FIGS. 10-13, another vacuum cleaner assembly 100 according to another aspect of the present disclosure is depicted. The vacuum cleaner assembly 100 of FIGS. 10-13 is essentially identical to the vacuum cleaner assembly 10 of FIGS. 1-7 except the vacuum cleaner assembly 100 is depicted with a hose 182 attached to the vacuum cleaner 21. In this example, the hose 182 is entirely disposed within the vacuum cleaner area 18 of the mounting plate 120. As will be appreciated, parts of the vacuum cleaner assembly 100 of FIGS. 10-13 identical to parts of the vacuum cleaner assembly 10 of FIGS. 1-7 include the same reference numerals and are not described again here for the sake of brevity. In addition, parts of the vacuum cleaner assembly 100 similar to the vacuum cleaner assembly 10, but having differences such as those described above, are numbered 100 more that the parts of the vacuum cleaner assembly 10 for consistency.

Referring now to FIG. 10, the vacuum cleaner assembly 100 includes the mounting plate 120 having a body 130 and a hose storage area 180. As further depicted, and like the vacuum cleaner assembly 10, the vacuum cleaner assembly 100 also includes the vacuum storage area 14, the tool storage area 16 (FIG. 12), and the accessory storage area 20. Thus, the mounting plate 120 of the vacuum cleaner assembly 100 may include up to four storage areas within a single body 130 of the mounting plate: the hose storage area 180, the vacuum storage area 14, the tool storage area 16, and the accessory storage area 20. In addition, in this example, a hose 182 extends from the collector module 24 of the vacuum cleaner 21 into the hose storage area 180 and rests on top of the crevice tool 28 of the tool storage area 16 when the hose 182 is not in use, as depicted in FIG. 12 and explained more below. In another example, the body 130 of the mounting plate 120 includes the hose storage area 180, the vacuum storage area 14, and the accessory storage area 20 only. So constructed, the mounting plate 120 is provides a single piece mounting body 130 for the vacuum cleaner 21, the accessory package 30, one or more tools of the tool storage area 16, and the hose 182, allowing easy installation and removal of the vacuum cleaner assembly 100.

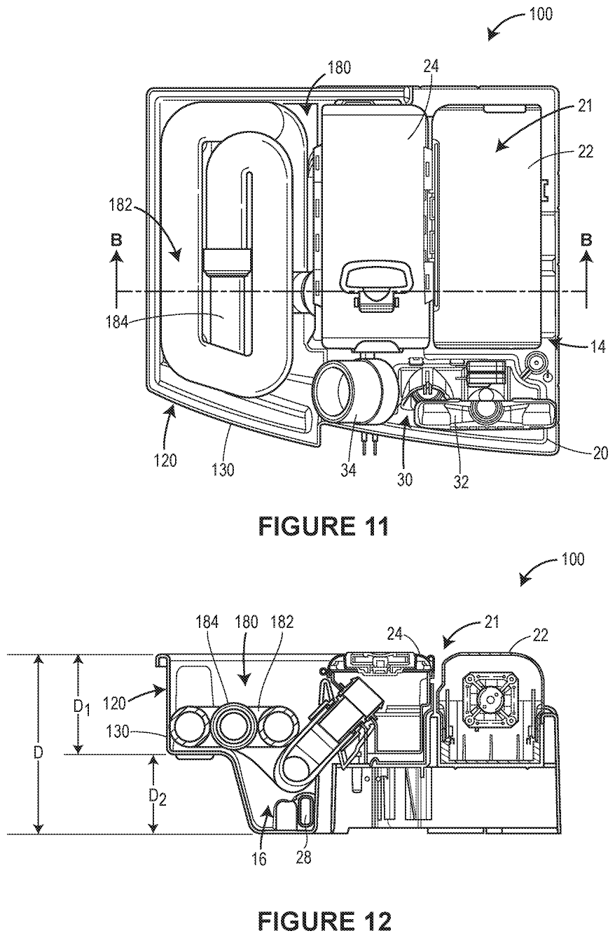

As depicted in FIG. 11, the hose storage area 180 is disposed adjacent to the tool storage area 16 and the collector module 24 disposed in the vacuum cleaner area 14. In addition, the accessory storage area 20 is disposed adjacent to the vacuum module 22 disposed in the vacuum cleaner area 14. In addition, the hose storage area 180 includes a depth D (FIG. 12). This depth D allows the hose 182 to be disposed in in multiple layers, for example. In addition, the hose 182 may also be disposed in a serpentine arrangement, as depicted in FIG. 11. In one example, the depth D includes a first depth D1 in an upper portion of the hose storage area 180 and a second depth D2 in a lower portion of the hose storage area, the second depth D2 disposed beneath the first depth D1.

Further, and as depicted in both FIGS. 11 and 12, the hose 182 includes an end 184 also disposed in the hose storage area 180 of the mounting plate 120. In this example, the hose 182 and the end 184 of the hose 182 are entirely disposed within the hose storage area 180 of the mounting plate 120. In addition, and in one example, the end 184 of the hose 182 is disposed in a center area of the hose storage area 180 between the hose 182.

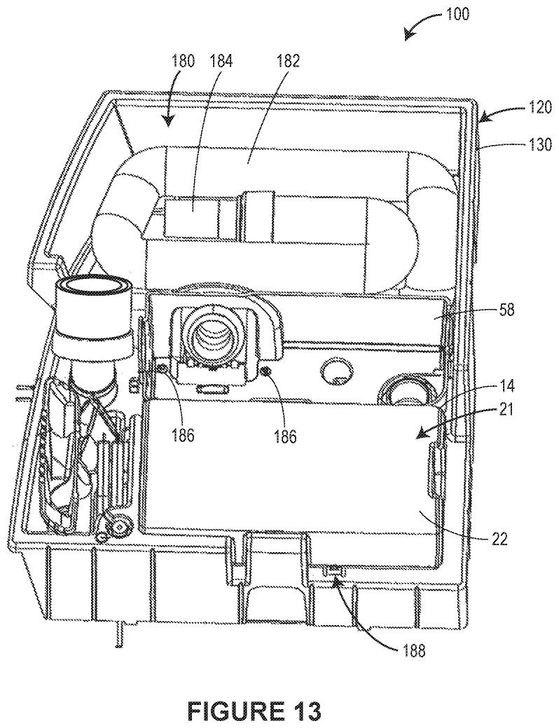

Referring now to FIG. 13, the liner 58 of the collector module 24 is depicted, and the canister assembly 56 has been removed from the collector module 24. The liner 58 is secured to the vacuum cleaner area 14 of the mounting plate 120 by at least one fastener 186, such as a pair of fasteners 186. In addition, the vacuum storage area 14 further includes a latch 188. In another example, the vacuum module 22 of the vacuum cleaner 21 snaps into the latch 188 to help secure the vacuum module 22 to the mounting plate 120.

While not depicted for the mounting plate 120 of the vacuum cleaner assembly 100 of FIGS. 10-13, the vacuum cleaner area 14 and the hose storage area 20 of the mounting plate 120 include the same structural features as the mounting plate 12 described above and depicted in FIGS. 8 and 9. For example, the mounting plate 120 also includes the open-ended compartment 80, the pair of walls 82, the first side 84, and the second side 86 of the vacuum cleaner area 14. In addition, all other features of the mounting plate 12 described above in FIGS. 8-9, for example, are also included in the mounting plate 120 of FIGS. 10-13 and are not repeated again here for the sake of brevity.

In view of the foregoing, it will be appreciated that the vacuum cleaner assemblies 10, 100 described above include several advantages. As noted, the mounting plates 12, 120 each provide a single piece mounting body that houses the vacuum cleaner 21, one or more the hose 182 and the tool 28, and the accessory package 30, for example. So configured, this enables easy installation of all of these parts of the vacuum cleaner assembly 10, 100 into the vehicle, as only the mounting plate 12, 120 is to be secured to the vehicle. In addition, this further enables easy removal of the vacuum cleaner assembly 10, 100 from a vehicle when desired, as again only the mounting plate 12, 120 needs to be unsecured from the vehicle to effect removal, for example. The simplicity of the new construction further simplifies and/or reduces the steps of the installation and removal of the vacuum cleaner assemblies 10, 100, reducing the time required to both install and removed the vacuum cleaner assembles 10, 100 from the vehicle. As a result, more efficient installation and removal processes are achieved.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

As used herein any reference to “one example” or “an example” means that a particular element, feature, structure, or characteristic described in connection with the embodiment is included in at least one embodiment. The appearances of the phrase “in one example” in various places in the specification are not necessarily all referring to the same example.

Some examples may be described using the expression “coupled” and “connected” along with their derivatives. For example, some examples may be described using the term “coupled” to indicate that two or more elements are in direct physical or electrical contact. The term “coupled,” however, may also mean that two or more elements are not in direct contact with each other, but yet still cooperate or interact with each other. The examples are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B is true (or present).

In addition, use of the “a” or “an” are employed to describe elements and components of the embodiments herein. This is done merely for convenience and to give a general sense of the description. This description, and the claims that follow, should be read to include one or at least one and the singular also includes the plural unless it is obvious that it is meant otherwise.

This detailed description is to be construed as examples and does not describe every possible embodiment, as describing every possible embodiment would be impractical, if not impossible. One could implement numerous alternate embodiments, using either current technology or technology developed after the filing date of this application.

While various embodiments have been described herein, it is understood that the appended claims are not intended to be limited thereto, and may include variations that are still within the literal or equivalent scope of the claims.

1. A vacuum cleaner assembly configured to be mounted in a vehicle, the vacuum cleaner assembly comprising:
a mounting plate configured to be mounted to a vehicle, the mounting plate having a vacuum cleaner area, a hose storage area, a tool storage area adapted to receive a tool, and an accessory storage area adapted to receive an accessory package, the vacuum cleaner area having an open-ended compartment and a pair of walls disposed adjacent to the open-ended compartment,
a vacuum cleaner disposed in the vacuum cleaner area of the mounting plate, the vacuum cleaner including:
a collector module configured to collect debris and having a liner mounted to the vacuum cleaner area; and
a vacuum module configured to draw a vacuum and operatively coupled to the collector, the vacuum module secured to the vacuum cleaner area by one or more of the open-ended compartment and the pair of walls disposed adjacent to the open-ended compartment;
where the mounting plate is configured to provide a single piece mounting body for the vacuum cleaner and one or more of the tool and the accessory package, allowing ease of installation and removal of the vacuum cleaner assembly.

2. The vacuum cleaner assembly of claim 1, wherein the mounting plate further includes a latch disposed in the vacuum cleaner area, and the vacuum module is further secured to the vacuum cleaner area by the latch.

3. The vacuum cleaner assembly of claim 1, wherein the tool storage area is disposed adjacent to the collector module, the hose storage area is disposed adjacent to the tool storage area, and the accessory storage area is disposed adjacent to the open-ended compartment of the vacuum cleaner area.

4. The vacuum cleaner assembly of claim 1, wherein the mounting plate further includes an exhaust port disposed in one wall of the pair of walls disposed adjacent to the open-ended compartment, the one wall of the pair walls is an outer wall of the pair of walls, enabling exhaust air from the vacuum module to be emitted out of the mounting plate during operation of the vacuum cleaner.

5. The vacuum cleaner assembly of claim 1, the mounting plate further comprising an exhaust port including an exhaust cover forming a bottom portion of an exhaust chamber.

6. The vacuum cleaner assembly of claim 1, wherein the pair of walls includes an outer wall, and the mounting plate further includes a rear wall, a first exhaust port disposed in the outer wall of the pair of walls of the vacuum storage area, and a second exhaust port disposed in the rear wall of the mounting plate.

7. The vacuum cleaner assembly of claim 1, wherein the collector module is disposed immediately adjacent to the vacuum module in the vacuum cleaner area of the mounting plate, and the vacuum module includes a motor/impeller unit disposed within a motor housing.

8. The vacuum cleaner assembly of claim 1, wherein the tool storage area of the mounting plate further includes at least one mounting hole for receiving a securing member adapted to secure the mounting plate to the vehicle.

9. The vacuum cleaner assembly of claim 1, wherein the hose storage area includes a plurality of mounting holes, each mounting hole adapted to receive a securing member adapted to secure the mounting plate to the vehicle.

10. The vacuum cleaner assembly of claim 1, wherein the tool storage area includes a locking assembly for removably locking a tool in the tool storage area, the locking assembly including a pair of walls, each wall of the pair of walls having an inwardly extending tab, the tabs contacting the tool upon insertion of the tools between the walls to snap the tool into the locking assembly.

11. A vacuum cleaner assembly configured to be mounted in a vehicle, the vacuum cleaner assembly comprising:
a mounting plate having a vacuum cleaner area, a hose storage area, and an accessory storage area adapted to store an accessory package, the vacuum cleaner area having an open-ended compartment and a pair of walls disposed adjacent to the open-ended compartment;
a vacuum cleaner disposed in the vacuum cleaner area of the mounting plate, the vacuum cleaner including:
a collector configured to collect debris and having a liner mounted to the vacuum cleaner area, a hose extending from the collector into the hose storage area of the mounting plate; and
a vacuum unit configured to draw a vacuum and operatively coupled to the collector, the vacuum unit secured to the vacuum cleaner area by one or more of the open-ended compartment and the pair of walls;
where the mounting plate is configured to provide a single piece mounting body for the vacuum cleaner and one or more of the hose and the accessory package, allowing ease of installation and removal of the vacuum cleaner assembly.

12. The vacuum cleaner assembly of claim 11, wherein the mounting plate further includes a latch disposed in the vacuum cleaner area, and the vacuum unit is further secured to the vacuum cleaner area by the latch.

13. The vacuum cleaner assembly of claim 11, wherein the hose storage area is disposed adjacent to the collector, and the accessory storage area is disposed adjacent to the open-ended compartment of the vacuum cleaner area.

14. The vacuum cleaner assembly of claim 11, wherein the mounting plate further includes an exhaust port disposed in one wall of the pair of walls disposed adjacent to the open-ended compartment, the one wall of the pair walls is an outer wall of the pair of walls, enabling exhaust air from the vacuum unit to be emitted out of the mounting plate during operation of the vacuum cleaner.

15. The vacuum cleaner assembly of claim 11, wherein the mounting plate further includes one of a first exhaust port disposed in an outer wall of the pair of walls of the vacuum storage area, and a second exhaust port disposed in a rear wall of the mounting plate, or an exhaust port including an exhaust cover forming a bottom portion of an exhaust chamber

16. The vacuum cleaner assembly of claim 11, wherein the collector is disposed immediately adjacent to the vacuum unit in the vacuum cleaner area of the mounting plate, and the vacuum unit includes a motor/impeller 1 unit disposed within a motor housing.

17. The vacuum cleaner assembly of claim 11, wherein the hose storage area of the mounting plate further includes a depth enabling the hose to be disposed in one or more of a serpentine arrangement and multiple layers, the hose having an end disposed in the hose storage area.

18. The vacuum cleaner assembly of claim 11, wherein the accessory storage area includes a plurality of mounting holes, each mounting hole adapted to receive a securing member adapted to secure the mounting plate to the vehicle.

19. The vacuum assembly of claim 11, wherein the vacuum cleaner assembly further includes a tool storage area disposed adjacent to the hose storage area, the hose of the hose storage area disposed over the tool storage area.

20. A mounting plate for a vacuum cleaner assembly configured to be mounted in a vehicle, the mounting plate comprising:
a vacuum cleaner area having an open-ended compartment, a pair of walls, a first side, and a second side, the vacuum cleaner area adapted to receive a vacuum cleaner having a collector module and a vacuum module operatively coupled to the collector module, where one or more of the open-ended compartment and the pair of walls secure the vacuum module to the vacuum cleaner area;
one of a hose storage area or a tool storage area disposed adjacent to the first side of the vacuum cleaner area; and
an accessory area disposed adjacent to the second side of the vacuum cleaner area, the accessory area adapted to receive an accessory package;
where the mounting plate is configured to provide a single piece mounting body for the vacuum cleaner assembly.

21. The mounting plate of claim 20, wherein the open-ended compartment comprises a C-shaped wall and the vacuum cleaner area includes a latch, the latch adapted to further secure the vacuum module to the vacuum cleaner area.

22. The mounting plate of claim 20, further comprising one of an exhaust port disposed in one wall of the pair of walls disposed adjacent to the open-ended compartment, the one wall of the pair of walls is an outer wall, enabling exhaust air from the vacuum module to be emitted out of the exhaust port during operation of the vacuum cleaner or an exhaust port including an exhaust cover forming a bottom portion of an exhaust chamber.

23. The mounting plate of claim 20, further comprising a first exhaust port disposed in an outer wall of the pair of walls of the vacuum storage area, and a second exhaust port disposed in a rear wall of the mounting plate. 20 wherein the tool storage area of the mounting plate further includes at least one mounting hole for receiving a securing member adapted to secure the mounting plate to the vehicle.

25. The mounting plate of claim 20, wherein the hose storage area includes a plurality of mounting holes, each mounting hole adapted to receive a securing member adapted to secure the mounting plate to the vehicle.

26. The mounting plate of claim 20, wherein the tool storage area includes a locking assembly for removably locking a tool in the tool storage area, the locking assembly including a pair of walls, each wall of the pair of walls having an inwardly extending tab, the tabs contacting the tool upon insertion of the tools between the walls to snap the tool into the locking assembly.

27. The mounting plate of claim 20, wherein the hose storage area of the mounting plate further includes a depth enabling the hose to be disposed in one or more of a serpentine arrangement and multiple layers, the hose having an end disposed in the hose storage area.
